(19) United States
(12) Patent Application Publication
(10) Pub. No.: US 2004/0182770 A1
(43) Pub. Date: Sep. 23, 2004

(54) Combination laboratory device with multifunctionality

(76) Inventors: Phillip Clark, Wakefield, MA (US); Chris A. Scott, Westford, MA (US); Michael S. Colman, Beverly, MA (US)

Correspondence Address: Kevin S. Lemack, Nields & Lemack, Suite 7, 176 E. Main Street, Westboro, MA, 01581, US

(21) Appl. No.: 10/726,240

(22) Filed: Dec. 2, 2003

Related U.S. Application Data
(60) Provisional application No. 60/434,570, filed on Dec. 18, 2002.

(51) Int. Cl. B01D 63/00

(52) U.S. Cl. 210/321.6; 210/323.1; 422/101

(57) ABSTRACT

A laboratory device design particularly for a multiplate format that includes a plate or tray having a plurality of utilitarian discontinuities such as reaction chambers or wells, wherein at least two of the discontinuities have different functionalities. In a preferred embodiment, the device is a multiwell plate or tray that meets SBS dimensional standards guidelines and is therefore automation compatible. In one embodiment, the device is a multiwell plate or tray that has a modular design, wherein removable inserts with different functionalities can be placed in a base. The particular inserts chosen depend on the desired sample preparation or assay to be carried out.

This application claims priority of provisional application Serial No. 60/434,570 filed Dec. 18, 2002, the disclosure of which is hereby incorporated by reference.

### BACKGROUND OF THE INVENTION

Test plates for chemical or biochemical analyses, which contain a plurality of individual wells or reaction chambers, are well-known laboratory tools. Such devices have been employed for a broad variety of purposes and assays, and are illustrated in U.S. Pat. Nos. 4,734,192 and 5,009,780, for example. Microporous membrane filters and filtration devices containing the same have been well used in sterilization and general sample preparation, and have become particularly useful with many of the recently developed cell and tissue culture techniques and assays, especially in the fields of bacteriology and immunology. Multiwell plates, used in assays, often utilize a vacuum applied to the underside of the membrane as the driving force to generate fluid flow through the membrane. The microplate has been used as a convenient format for sample processing such as pipetting, washing, shaking, detecting, storing, etc. These products have also enjoyed success for SEQ and PCR reaction clean-up of genomics samples, using both manual and automated laboratory procedures and equipment.

For example, a suitable sample process used to clean up a SEQ or PCR reaction is as follows:

1. The amplified sample is dispensed into a multiwell filter plate with an ultrafiltration (UF) membrane and filtered through the membrane via vacuum force.

2. A series of sample washes are then processed by vacuum filtration. The washes remove the unused SEQ or PCR reagents from the sample.

3. The sample product that is retained on the UF membrane is then resuspended into a small volume of liquid that is dispensed into each filter well.

4. The resuspended sample product is removed with a pipette from each well and transferred into a storage or test well. The storage device is typically a separate solid bottom 96 or 384 well plate.

Typically, a 96-well or 384-well filtration plate is used to conduct multiple assays simultaneously. In the case of multiwell filtration products, a membrane is placed on the bottom of each of the wells. The membrane has specific properties selected to filter or to support biological or chemical reactions. High throughput applications, such as DNA sequencing, PCR product cleanup, plasmid preparation, drug screening and sample binding and elution require products that perform consistently and effectively.

The typical multiwell plate has a uniform arrangement of wells where all the wells have a common size, shape and function. Should a user have less then a full multiwell plate of samples, then they have to decide whether to combine batches to fill the plate or use a partial plate and cover the unused area of the plate for later use. Neither approach is ideal, combining of samples can extend over a time that may be too long, and can also lead to sample tracking problems. Covering and reusing is also undesirable because of the potential for contamination of the used wells, and the storing of used wet product over time.

The Society for Biomolecular Screening (SBS) has published guidelines or microplate design covering certain dimensional standards, necessary features, and general plate layout in response to non-uniform commercial products. Specifically, the dimensions of microplates produced by different vendors varied, causing numerous problems when microplates were to be used in automated laboratory instrumentation. Such problems include fitting within the deck and in the stackers, and with re-programming of the liquid handlers. The SBS guidelines address these variances by providing dimensional limits for microplates intended for automation. The design and engineering of commercial products that are to be in compliance with the SBS guidelines is therefore inherently limited by these dimensions and general layout.

Recently, genomics companies are re-sizing their sample processing operations to meet the reduced number of samples that have to be processed due to the completion of the human, mouse, rice and other genome sequences. Although fewer samples are being processed, for economical purposes it remains desirable to minimize the volume of the samples and reagents involved. For example, although a 384-well plate may not be necessary from the standpoint of the number of samples being simultaneously processed, the volume of the wells in a 384-well plate (100 μl) may be desirable for the particular application. However, for these low well volumes, 384-wells would be needed to fill the space required by the SBS guidelines. This would waste valuable deck and storage space by creating unused dead-space. For example, one may want to process 24-100 microliter samples with a simple filtration and subsequent wash step. Currently, this would require two separate plates, each partially filled. Storage would require the space of the entire 384-SBS plate.

It would be desirable to compress the needed experiment space into a smaller footprint, such as reducing the number of microplates needed, and removing unused dead-space. It would be desirable to further reduce the total space required for subsequent steps such as incubating and storage of samples.

It further would be desirable to provide a multiplate format that is automation compatible, has appropriate well size for reduced sample volume applications, and is multifunctional.

It also would be desirable to provide a multiplate format that provides flexibility to the user with inserts having different functionality that can be assembled into an SBS footprint to suit the laboratory task to be preformed.

It also would be desirable to provide a multiwell format that has a scalable sample processing format for the small laboratory that does not require re-optimization as the laboratory sample numbers increase.

It still further would be desirable to provide a multiwell format that can have reagents preloaded is into inserts within the SBS footprint, thereby providing an economical way of batch producing commonly used reagents.

### SUMMARY OF THE INVENTION

The problems of the prior art have been overcome by the present invention, which provides a laboratory device design particularly for a multiplate format that includes a plate or tray having a plurality of utilitarian discontinuities, such as reaction chambers or wells, wherein at least two of the utilitarian discontinuities have different functionalities. In a preferred embodiment, the device is a multiwell plate or tray that meets SBS guidelines and is therefore automation compatible. The multiwell plate can be a single piece, or multi-piece unit. The volume of the wells used for sample preparation is relatively small; thus, in a design where 96 or 48 wells are used, those wells may have the volume of wells typically used in a 384-well design.

In one embodiment of the present invention, the device has a modular design, wherein removable inserts with different functionalities can be placed in a base. The particular inserts chosen depend on the desired sample preparation or assay to be carried out.

### BRIEF DESCRIPTION OF THE DRAWINGS

FIG. 1 is a top view of a multiwell device in accordance with an embodiment of the present invention;

FIG. 2 is a bottom view of the device of FIG. 1;

FIG. 3 is a schematic illustration of a laboratory device in accordance with an embodiment of the present invention;

FIGS. 4A and 4B are perspective views of a laboratory device in accordance with another embodiment of the present invention;

FIG. 5 is a top view of a discrete region of a laboratory device in accordance with the present invention;

FIG. 6 is an exploded view of a laboratory device in accordance with another embodiment of the present invention; and

FIG. 7 is an schematic illustration of a laboratory device in accordance with another embodiment of the present invention.

### DETAILED DESCRIPTION OF THE INVENTION

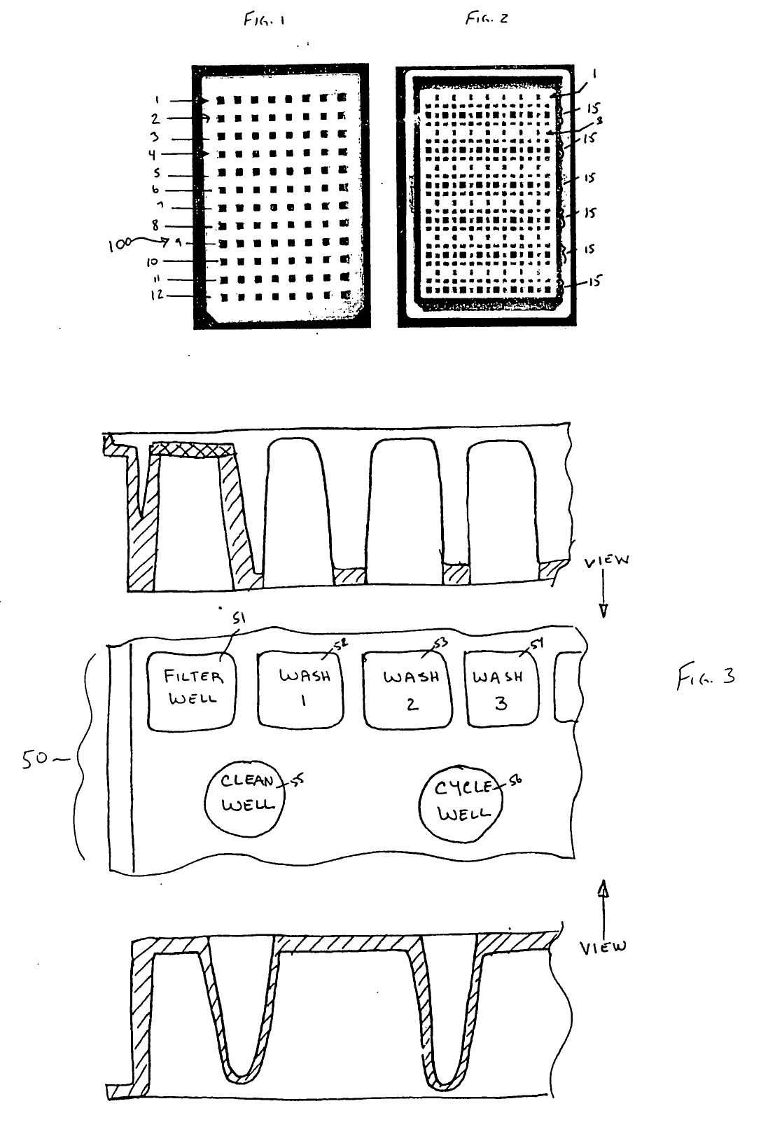

Turning first to FIG. 1, there is shown a device in accordance with one embodiment of the present invention wherein the utilitarian discontinuities are wells. The term “utilitarian” as used herein means that the device has a surface that includes discontinuities that contribute a positive function to the device, which discontinuities may be random or ordered, regular or irregular. The term “discontinuities” refers to portions of the surface that are non-planar. In this embodiment, the discontinuities are wells or reaction chambers formed in the surface, and the device is a 96-well plate or tray 100. Other representative discontinuities include one or more protruberances that can be coated (such as with an affinity resin) or uncoated, one or more apertures, channels, grooves, slots, depressions, projections, tubes, etc., that can satisfy numerous functionalities, including size separation (depth, microporous and ultrafiltration), absorption (affinity chemistries such as coated tubes and wells, particles, membranes and chromatographic media), in-gel digestion and simple liquid isolation chambers. Although a 96-well plate array is illustrated, those skilled in the art will appreciate that the number of wells is not limited to 96; standard multiwell formats with 48, 24 or fewer or more wells are within the scope of the present invention. It is desirable that the spacing between well, both within a function and between functions, is a multiple of 4.5 mm according to SBS guidelines. The well or wells are preferably cylindrical with fluid-impermeable walls, and have a width and depth according to the desired use and amount of contents to be sampled. Where a plurality of wells is present, the wells of the same functionality are preferably arranged in a uniform array, with uniform depths so that the tops and bottoms of the wells are planar. The plate 100 is generally rectangular, although other shapes are within the scope of the present invention, keeping in mind the objective of meeting SBS guidelines.

In the embodiment shown, the plate 100 includes a plurality of wells (forty-eight) having an open top and a bottom having a surface to which is sealed a support, such as a membrane. The sealing can be accomplished by any suitable means, including heat-sealing, sealing with ultrasonics, solvents, adhesives, by diffusion bonding, etc. The type of membrane suitable is not particularly limited, and by way of example can include nitrocellulose, cellulose acetate, polycarbonate, polypropylene and PVDF microporous membranes, or ultrafiltration membranes such as those made from polysulfone, PVDF, cellulose or the like. Additionally, materials also include depth filters, nonwovens, woven meshes and the like, depending upon the application. A single support covering all of the wells could be used, or each well can contain or be associated with its own support that can be the same or different from the support associated with one or more of the other wells. Each such individual support is preferably coextensive with the bottom of its respective well.

In the embodiment shown, the utilitarian functionality of these 48 wells is for sample preparation, such as sample concentration, desalting or purification. Those skilled in the art will appreciate that the functionality of these wells could be accomplished by means other than the membranes listed above. For example, these wells (or other discontinuities) could include chromatographic media, such as that used in the ZipTip® device commercially available from Millipore Corporation. Thus, U.S. Pat. Nos. 6,048,457 and 6,200,474 (the disclosures of which are hereby incorporated by reference) teach the formation of cast membrane structures for sample preparation that are formed by phase inversion of a particle-loaded polymer system at the housing orifice. The polymer is precipitated when the housing (containing the soluble polymer/particle lacquer) is immersed in a precipitation bath (typically water). The resulting three-dimensional structure is capable of carrying out solid phase extraction.

Another example of a suitable functionality of these wells is for enzyme linked immuno-spot (ELISPOT) assays, which does not involve filtration. In an ELISPOT assay, for example, the wells are coated with an antibody that is specific for the cytokine that is being assayed for. The antibody binds to the nitrocellulose or polyvinylidene fluoride (PVDF) membrane portion of the ELISPOT plate. Activated peripheral mononuclear cells are transferred to the plate, and the cytokines are released during an incubation period. The released cytokines bind to and are therefore captured by the specific antibody. The cells and excess cytokines are washed away, and a second antibody also specific for the cytokine of interest that is coupled to an enzyme capable of converting a substrate into an insoluble colored product is added. The substrate is converted into an insoluble product, forming spots or colors that represent the areas of captured cytokines. The spots can be quantitated using a microscope or digital imaging system. The ELISPOT assay provides an effective method of measuring antibody or cytokine production of immune cells on the single cell level.

In the embodiment shown, the 48 wells having the same functionality are through holes with an ultrafiltration membrane sealed over the bottom opening. These wells are positioned in a plurality of spatially discrete regions, which in this embodiment are alternating rows. Thus, rows 2, 4, 6, 8, 10 and 12 are filtration rows, each row having eight such wells. Preferably the wells in each row are uniformly spaced and are uniformly dimensioned. Alternating with the rows of filtration wells are rows of wells 1, 3, 5, 7, 9 and 11 having a different functionality from the wells in rows 2, 4, 6, 8, 10 and 12. For example, the wells in rows 1, 3, 5, 7, 9 and 11 can be collection wells, having solid bottoms for receiving cleaned product. Suitable bottoms include flat bottoms, V-shaped bottoms and conical bottoms, and suitable well configurations include round, square or any other shape suited to the application. It may be desirable to vary the well shape between the filtration wells and the collection wells so that they are easily distinguishable. Thus, one suitable configuration has square filtration wells and round collection wells. Those skilled in the art will notice that each functional discontinuity can have different enclosed volumes from other functional discontinuities on the same plate, due to variation is shape and depth.

Those skilled in the art will appreciate that numerous arrangements of the discontinuities of different functionalities can be designed. For example, the alternating rows of collection and filtration wells shown in FIG. 1 could be rotated 90° so that there are four alternating collection rows of 12 wells each, and four alternating filtration rows of 12 wells each. Futhermore, the size and the shape can vary depending on the function of the discontinuity.

In the case where a membrane is used to impart functionality to selected wells, the membrane can be sealed to the device as a single sheet in a manner conventional in the art. However, this may not be desirable, since when the samples are filtered and washed through the membrane, the solutions passing through the membrane can migrate and wet the supporting structure of the membrane. This may contaminate the underside of the membrane of neighboring wells that are not being used, or that are not being used for filtration. In order to isolate the filtration wells, the membrane can be cut or precut in the appropriate configuration so that only the filter wells are sealed to membrane. One way to accomplish this to provide the membrane with a film, such as a polyester film, with low tack adhesive laminated to the support structure of the membrane. The membrane is then cut into suitable coupons, such as strips where the filtration wells are arranged in rows, with the film remaining untouched and acting as a backbone. A conventional bonding process is then used, with an adhesive (such as a UV curable adhesive) applied only to the perimeter of the filter wells. After the adhesive curing process is complete, the film is removed from the underside of the plate, thereby removing the unbounded portion and leaving only the portion covering the filter wells, as shown by strips 15 in FIG. 2. Liquids passing through the filter wells will not migrate transversely through the membrane to adjacent wells because the membrane conduit is removed. Alternatively, the filter wells can be isolated by gridding the membrane into isolation coupons using the same approach, or by die cutting in place, laser cutting in place or with ultrasonic separation. Alternatively still, the wells themselves can be designed so that each filter region is a distinct, separate island, such as is the case with the MULTISCREEN®-96 device commercially available from Millipore Corporation.

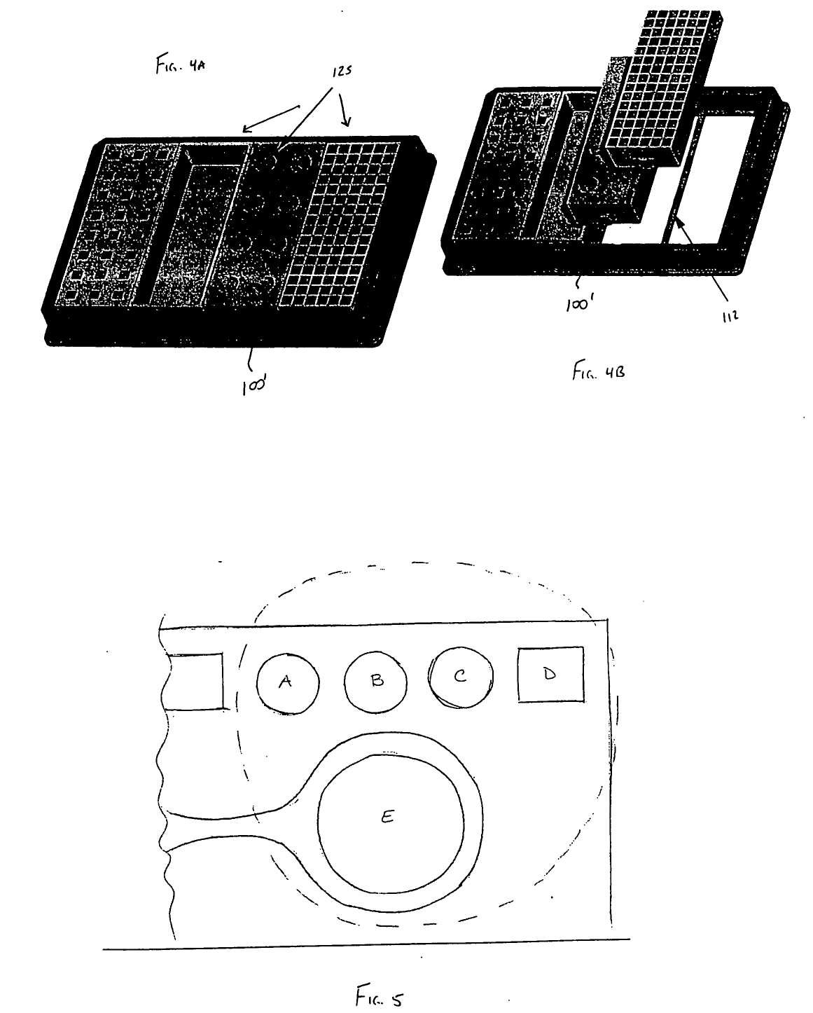

As noted previously, the orientation of the discontinuities need not be arranged in rows as shown in FIG. 1. For example, the spatially discrete regions of different functionality can be arranged to facilitate carrying out an assay, effectively creating a “lab on a plate” format. An example of this is shown in FIG. 3. A discrete region 50 of the device includes sub-regions 51, 52, 53, 54, 55 and 56, at least some of which having discontinuities with different functionality from other discontinuities within the discrete region 50. Thus, one functionality is exhibited by a filter well 51 defining a sub-region, which filter well 51 is an open-ended well with a membrane sealed to its bottom, used for sample clean up. A second functionality is exhibited by a further sub-region within the discrete region, namely, three wash wells 52, 53, 54 that can be preloaded with wash solution used to clean the product such as by vacuum filtration. These wells are shown in a sequential pattern placed in the same row as the filtration well 51, although other locations within the discrete region 50 are acceptable. A still further functionality is exhibited by an adjacent row with two collection wells. One collection well 55 is a clean well, suitable for receiving the filtered product after clean up, for storage. The other well 56 is a cycle well, suitable for containing sequencing or PCR chemistries. In this embodiment, the well 56 must have a thin wall, must be suitable for thermal cycling, and the top surface may require a puncturable and resealable cover or the like.

Consistent with SBS standards, in the FIG. 3 embodiment where the wells are sized the same as the wells in a conventional 384-well plate (e.g., 100 μl), the plate will accommodate twelve 6-well discrete regions 50. Similarly, in the FIG. 3 embodiment where the wells are sized the same as the wells in a conventional 96-well plate (e.g., 300 μl), the plate will accommodate three 6-well discrete regions 50. Each of the regions need not be made up of discontinuities having the same functionality as the discontinuities in another region; sub-regions with one or more discontinuities having different functionalities from other sub-regions within a discrete region are within the scope of the present invention.

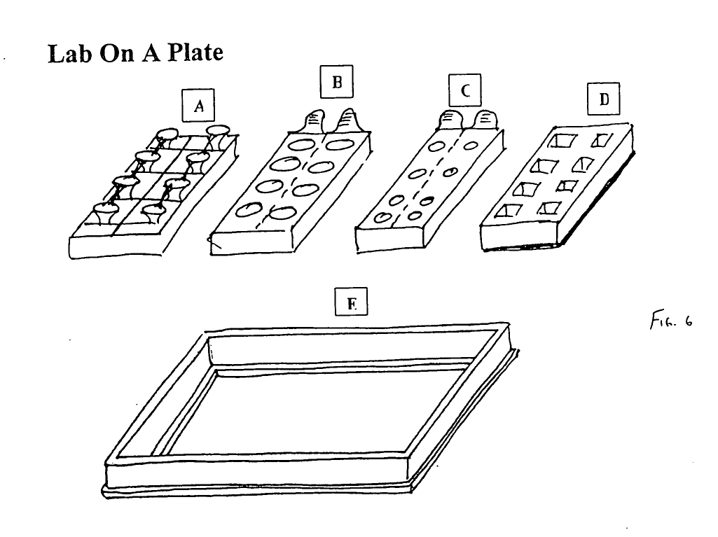

In a further embodiment, FIGS. 4A and 4B show one or more of the discrete regions as a replaceable insert containing the configuration of interest. Preferably the size, number and spacing of the inserts 125 is such that the compatibility of plate 100′ with robotics equipment is not affected, and the dimensional standards established in the industry are maintained. Thus, standard SBS base plate 100′ is an open frame where an overmolded gasket 112 for sealing the inserts 125 can be provided if the application, like vacuum filtration, is required. Other means of creating a liquid and airtight seal include removable gaskets, or other compressible material, and are not limited to overmolding. Where an individual insert includes a plurality of wells, the functionality of each of the wells can be the same (as in the case of inserts shown in FIG. 4A) or can comprise discrete sub-regions where the functionality of individual wells is different. Although in the embodiment shown, there are four inserts of equal dimension, there could be fewer or more inserts, and the dimensions of each insert need not be the same. One or more of the inserts could be a MALDI target, in which case another of the inserts could include MALDI matrix solution. Preferably the inserts are molded out of a material that is not deleterious to the application. Each insert can be of a different material from the base and from each other insert. Polyolefins, particularly polypropylene and polyethylene, are suitable materials for most applications. Polystyrene, Acrylic, PETG, ABS and other materials are also suitable for plate frames and plate inserts. Also, some of the inserts like troughs and tube racks could be vacuum or pressure forming films. The removability of the inserts 125 allows the user to remove one or more inserts 125 for storage, incubation or some other purpose. The removable inserts further allow the user to centrifuge, incubate for cell culture, PCR thermocycle, vacuum or pressure transfer, or carry out magnetic separation, for example. By making components removable, the user can limit the exposure of the portions of the plate and assay components to those stresses. Additionaly, the removability feature enables the user to mix and match components to suit the requirements of the laboratory procedure being preformed.

Mid-throughput laboratories often use 8-strip purification devices rather than single tubes or multiwell devices. The general acceptance of this format is evidenced by centrifugal rotors sold to accommodate this format. To address this format, the device of the present invention can include a discrete region having at least one utilitarian discontinuity capable of supporting one or more sample tubes, preferably an interconnected rack of such tubes. For example, one discrete region of the device can support an 8-strip containing samples to be purified. An adjacent discrete region is a row of filtration wells. Sample to be purified can be transferred from each of the eight sample tubes to a respective filtration well. After filtration, purified sample can be transferred to another discrete region supporting a second rack of sample tubes for storage of the purified sample. Thus, the second rack containing purified samples can be sealed and removed from the device (either manually or automatically) and stored at low temperature (e.g., 4° C., −20° C. or −80° C.), thereby eliminating the necessity of storing the entire device.

FIG. 7 is an illustration of a further embodiment that has a base 500 that compiles with the SBS guidelines. Postioned in the base are shown third replaceable and exchangeable inserts. Insert 501 is shown with round wells. The wells 502 can be solid bottomed with flat, slanted, U or V shaped which depends on the requirements of the application. The wells may also have a filter sealed across the open bottom end of the wells, where the filter may retain compounds of interest within the user would retrive those compound off the surface of the filter, or the application may be to clarify the sample in which case the filtrate needs to directed and collected. Also, positioned in the base 500 is insert 503. Insert 503 is shown with square wells 504 and like insert 501 can be configured with or without membrane and contain well shapes and sizes appropriate to the application being performed.

Shown in the center position in the base 1500 is a rack 506. Positioned in the rack are removable tubes 507. The tubes 507 are shown as being connected in a strip format but it is understood the tubes 507 can be individually position and removable. It is further understood that the tube 507 can be thin wall suitable for CR amplification or standard storage with or without caps. The inserts 501,504 and 506 are interchangeable within the base 500 to suit the processed being performed. In some applications the inserts will be sealed to the base for filtration by vacuum that is applied to the underside of the base.

### EXAMPLE 1

FIG. 5 shows an example of the present invention. In this format, a discrete region is defined by set wells A-E:

Wells:

A First wash solution, about 25 ul of liquid in a conical bottom well

B Second wash solution, about 25 ul of liquid in a conical bottom well

C Injection solution, about 25 ul of liquid in a conical bottom well

D SEQ clean up well, UF membrane sealed across bottom and vacuum filtered, about 100 ul volume

E Storage tubes, removable, the plate has a rack to hold the strip of tubes

The embodiment is shown as a row of wells along a multiwell plate. The pattern may repeat along the row, defining further discrete regions. Shown is a discrete sub-region defined by a row of wells A-D and a discrete sub-region defined by a row with racks E. The row of A-D wells may contain pre-loaded liquids in the A, B, C wells. If pre-loaded, then the wells would need to be sealed with a liquid tight removable or punchable film.

The protocol for using this plate for a SEQ Clean up is as follows:

Place the sample in well D and vacuum filter to dryness

Add 25 ul of first wash solution from well A into well D, and vacuum to dryness

Add 25 ul of second wash solution from well B into well D, and vacuum to dryness

Add 25 ul resuspension solution from well C into well D and agitate

Aspirate up 20 ul from well D and transfer storage tube in rack E.

Remove storage tube, seal and store.

### EXAMPLE 2

### Lab On A Plate

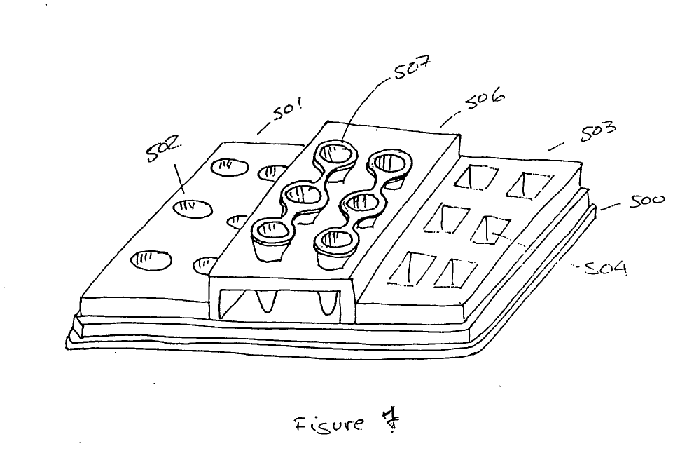

FIG. 6 is an illustration of the Lab On A Plate embodiment of the present invention. In this example the complete plate consists of the component A-E. Each component defines a discrete region and contains a function portion of the complete plate. The number of wells or tubes in each tray is matched, therefore forming a complete plate for processing 24 or 48 wells.

Components:

A A rack containing strips of storage tubes that are removable

B The first and second wash solution, about 50 ul of liquid in a conical bottom well

C The injection solution, about 25 ul of liquid in a conical bottom well

D SEQ clean up wells, UF membrane sealed across bottom and vacuum filtered, about 100 ul volume capacity

E The frame for holding the components. The frame is SBS or automation compatible. The frame should seal to a vacuum manifold, therefore the components need to seal into the frame.

The embodiment is shown as sets of wells and tubes combining to make a custom tailored multiwell plate. If preloaded, then the wells B and C would need to be sealed, with a liquid tight removable or punchable film.

The protocol for using this plate for a SEQ Clean up is as follows:

Place the sample in well D and vacuum filter to dryness

Add 25 ul of wash solution from well B into well D, and vacuum to dryness

Add 25 ul of wash solution from well B into well D, and vacuum to dryness

Add 25 ul resuspension solution from well C into well D and agitate

Aspirate up 20 ul from well D and transfer storage tube in rack A.

Remove storage tube, seal and store.

What is claimed is:

1. A laboratory sample process device comprising:
a surface comprising multiple spatially discrete regions, each region comprising at least one utilitarian discontinuity, wherein a utilitarian discontinuity in one of said regions has a functionality different from a utilitarian discontinuity in another of said regions.

2. The device of claim 1, wherein each of said plurality of discrete regions is arranged in a row.

3. The device of claim 1, wherein one of said functionalities is filtration.

4. The device of claim 3, wherein at least one of said utilitarian discontinuities is a well having filtration as its functionality and including a membrane.

5. The device of claim 4, wherein said membrane is an ultrafiltration membrane.

6. The device of claim 1, further comprising a base supporting said multiple spatially discrete regions, and wherein at least one of said discrete regions is removable from said base.

7. The device of claim 6, wherein said discrete regions are in sealing relationship with said base.

8. The device of claim 6, wherein said discrete regions comprise a support structure to position removable vessels.

9. The device of claim 1, wherein at least one of said discrete regions comprises a plurality of sub-regions defined by a plurality of utilitarian discontinuities, wherein at least one of said plurality of discontinuities in said sub-region has a functionality different from another of said discontinuities in said sub-region.

10. The device of claim 9, wherein said plurality of utilitarian discontinuities are wells.

11. The device of claim 1, wherein each of said plurality of discrete regions is arranged in a column.

12. The device of claim 1, wherein each of said plurality of discrete regions is arranged to include sub-regions having discontinuities with different functionality from other discontinuities within the discrete region.

13. The device of claim 1, wherein each of said plurality of discrete regions is arranged to include sub-regions having wells with different functionality from other wells within the discrete region and the sub-regions are selected from the group consisting of one or more filter wells, one or more wash wells, one or more component storage wells, one or more cycle wells and one or more empty storage wells and mixtures thereof.
